(19) United States
(12) Patent Application Publication
(10) Pub. No.: US 2025/0158122 A1
(43) Pub. Date: May 15, 2025

(54) NON-AQUEOUS ELECTROLYTE SECONDARY BATTERY

(71) Applicant: Panasonic Energy Co., Ltd., Moriguchi-shi, Osaka (JP)

(72) Inventor: Toshiyuki Nakamori, Osaka (JP)

(73) Assignee: Panasonic Energy Co., Ltd., Moriguchi-shi, Osaka (JP)

(21) Appl. No.: 18/832,241

(22) PCT Filed: Jan. 19, 2023
(86) PCT No.: PCT/JP2023/001551

§ 371 Date: Jul. 23, 2024

(30) Foreign Application Priority Data
Jan. 28, 2022 (JP) 2022-011612

(51) Int. Cl. H01M 10/0567; H01M 10/0568; H01M 10/0569

(52) U.S. Cl. CPC H01M 10/0567; H01M 10/0568; H01M 10/0569; H01M 2300/004

(57) ABSTRACT

In an embodiment of the present invention, this non-aqueous electrolyte secondary battery comprises a positive electrode, a negative electrode, and a non-aqueous electrolyte and is characterised in that the non-aqueous electrolyte contains 1,2-dimethoxyethane and the amount of 1,2-dimethoxyethane is 700 ppm or less relative to the total mass of the non-aqueous electrolyte.

### TECHNICAL FIELD

The present disclosure relates to a non-aqueous electrolyte secondary battery.

### BACKGROUND

In recent years, as a secondary battery having a high output and a high energy density, a non-aqueous electrolyte secondary battery that includes a positive electrode, a negative electrode, and a non-aqueous electrolyte and performs charging and discharging by moving lithium ions and the like between the positive electrode and the negative electrode has been widely used.

For example, Patent Literature 1 discloses a non-aqueous electrolyte secondary battery including a positive electrode, a negative electrode, and a non-aqueous electrolyte, in which a solvent of the non-aqueous electrolyte contains at least ethylene carbonate and 1,2-dimethoxyethane, and a mixing ratio of the 1,2-dimethoxyethane is greater than or equal to 10 vol % and less than or equal to 30 vol % with respect to the total solvent.

In addition, for example, Patent Literature 2 discloses a non-aqueous electrolyte secondary battery including at least a negative electrode, a positive electrode, and a non-aqueous electrolyte, in which a solution obtained by dissolving at least one compound selected from lithium borofluoride and lithium hexafluorophosphate in a mixed solution of ethylene carbonate and 1,2-dimethoxyethane is used as the non-aqueous electrolyte.

In addition, for example, Patent Literature 3 discloses a non-aqueous electrolyte for a lithium secondary battery containing a first non-aqueous solvent that is at least one of ethylene carbonate and diethylene carbonate and a second non-aqueous solvent that is 1,2-dimethoxyethane.

### CITATION LIST

### Patent Literature

Patent Literature 1: JP H04-284373 A
Patent Literature 2: JP H06-052888 A
Patent Literature 3: JP 2002-203595 A

### SUMMARY

Improvement of high-temperature storage characteristics is required for a non-aqueous electrolyte secondary battery used in recent severe environments.

An object of the present disclosure is to provide a non-aqueous electrolyte secondary battery having excellent high-temperature storage characteristics.

According to one aspect of the present disclosure, a non-aqueous electrolyte secondary battery includes a positive electrode, a negative electrode, and a non-aqueous electrolyte, in which the non-aqueous electrolyte contains 1,2-dimethoxyethane, and a content of the 1,2-dimethoxyethane is less than or equal to 700 ppm with respect to the total mass of the non-aqueous electrolyte.

According to one aspect of the present disclosure, it is possible to provide a non-aqueous electrolyte secondary battery having excellent high-temperature storage characteristics.

### BRIEF DESCRIPTION OF DRAWINGS

FIG. 1 is a cross-sectional view of a non-aqueous electrolyte secondary battery as an example of an embodiment.

### DESCRIPTION OF EMBODIMENTS

A non-aqueous electrolyte secondary battery of the present disclosure includes a positive electrode, a negative electrode, and a non-aqueous electrolyte, in which the non-aqueous electrolyte contains 1,2-dimethoxyethane, and a content of the 1,2-dimethoxyethane is less than or equal to 700 ppm with respect to the total mass of the non-aqueous electrolyte. The non-aqueous electrolyte secondary battery of the present disclosure has excellent high-temperature storage characteristics. Although the mechanism of exerting the effect is not sufficiently clear, the following is presumed.

The 1,2-dimethoxyethane contained in the non-aqueous electrolyte is preferentially adsorbed to a surface of a negative electrode active material constituting the negative electrode, such that a solid electrolyte interface (SEI) film formed on the surface of the negative electrode active material is stabilized. As a result, it is presumed that decomposition of the SEI film is suppressed during high-temperature storage of the battery, and thus, high-temperature storage characteristics are improved. However, when the amount of 1,2-dimethoxyethane contained in the non-aqueous electrolyte is increased, specifically, when the content of 1,2-dimethoxyethane is greater than 700 ppm with respect to the total mass of the non-aqueous electrolyte, the amount of 1,2-dimethoxyethane decomposed during high-temperature storage of the battery is increased, and the high-temperature storage characteristics are deteriorated. Therefore, an upper limit value of the content of 1,2-dimethoxyethane needs to be set to 700 ppm.

Hereinafter, an example of an embodiment will be described in detail. The drawings referred to in the description of embodiments are schematically illustrated, and dimensional ratios and the like of components drawn in the drawings may be different from actual ones.

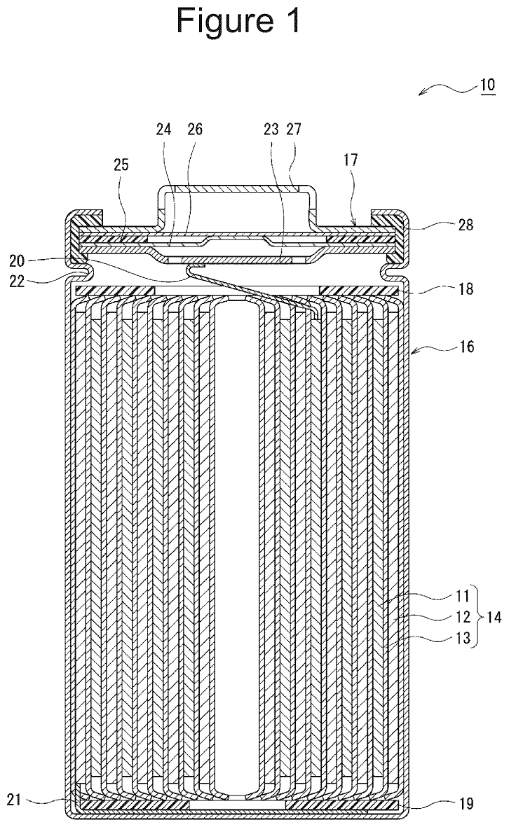

FIG. 1 is a cross-sectional view of a non-aqueous electrolyte secondary battery as an example of an embodiment. A non-aqueous electrolyte secondary battery 10 illustrated in FIG. 1 includes a wound electrode assembly 14 formed by wounding a positive electrode 11 and a negative electrode 12 with a separator 13 interposed between the positive electrode 11 and the negative electrode 12, a non-aqueous electrolyte, insulating plates 18 and 19 that are disposed on upper and lower sides of the electrode assembly 14, respectively, and a battery case housing the members and including a case body 16 and a sealing assembly 17. Note that, instead of the wound electrode assembly 14, another form of an electrode assembly such as a stacked electrode assembly in which a positive electrode and a negative electrode are alternately stacked with a separator interposed therebetween may be applied. In addition, examples of the battery case include a metal case having a cylindrical shape, a square shape, a coin shape, a button shape, or the like, and a resin case formed by laminating resin sheets (so-called laminate type resin case).

The case body 16 is, for example, a bottomed cylindrical metal container. A gasket 28 is provided between the case body 16 and the sealing assembly 17 to ensure the sealability inside the battery. The case body 16 has a projecting portion 22 in which, for example, a part of the side part of the case body 16 protrudes inward to support the sealing assembly 17. The projecting portion 22 is preferably formed in an annular shape along the circumferential direction of the case body 16, and supports the sealing assembly 17 on its upper surface.

The sealing assembly 17 has a structure in which a filter 23, a lower vent member 24, an insulating member 25, an upper vent member 26, and a cap 27 are sequentially stacked from the electrode assembly 14 side. Each member included in the sealing assembly 17 has, for example, a disk shape or a ring shape, and the members excluding the insulating member 25 are electrically connected to each other. The lower vent member 24 and the upper vent member 26 are connected to each other at the respective center regions, and the insulating member 25 is interposed between the respective peripheral portions. When the internal pressure of the non-aqueous electrolyte secondary battery 10 increases due to heat generated by an internal short circuit or the like, for example, the lower vent member 24 deforms so as to push the upper vent member 26 up toward the cap 27 side and breaks, and thus the current pathway between the lower vent member 24 and the upper vent member 26 is cut off. When the internal pressure further increases, the upper vent member 26 breaks, and gas is discharged from an opening of the cap 27.

In the non-aqueous electrolyte secondary battery 10 illustrated in FIG. 1, a positive electrode lead 20 attached to the positive electrode 11 extends to the sealing assembly 17 side through a through hole of the insulating plate 18, and a negative electrode lead 21 attached to the negative electrode 12 extends to the bottom side of the case body 16 through the outside of the insulating plate 19. The positive electrode lead 20 is connected to the lower surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to the bottom inner surface of the case body 16 by welding or the like, and the case body 16 serves as a negative electrode terminal.

### [Positive Electrode]

The positive electrode 11 includes a positive electrode current collector and a positive electrode mixture layer disposed on the positive electrode current collector. Note that the positive electrode mixture layer is desirably disposed on both surfaces of the positive electrode current collector.

As the positive electrode current collector, a foil of a metal stable in a potential range of the positive electrode, such as aluminum or an aluminum alloy, a film in which the metal is disposed on a surface layer, or the like can be used.

The positive electrode mixture layer contains, for example, a positive electrode active material. In addition, it is preferable that the positive electrode mixture layer contains a binder from the viewpoint of binding the positive electrode active materials to each other to secure the mechanical strength of the positive electrode mixture layer. In addition, it is preferable that the positive electrode mixture layer contains a conductive agent from the viewpoint of improving the conductivity of the layer.

The positive electrode 11 is manufactured, for example, as follows. First, a positive electrode active material, a binder, a conductive agent, and the like are mixed, and the mixture is dispersed in a solvent to prepare a positive electrode mixture slurry. Then, the positive electrode mixture slurry is applied onto the positive electrode current collector, a coating film is dried, and then the coating film is rolled, such that the positive electrode 11 can be manufactured.

The positive electrode active material is, for example, a lithium composite oxide capable of reversibly inserting and removing lithium. Examples of the metal element contained in the lithium composite oxide include Ni, Co, Mn, Al, B, Mg, Ti, V, Cr, Fe, Cu, Zn, Ga, Sr, Zr, Nb, In, Sn, Ta, and W. Among them, it is preferable to contain at least one of Ni, Co, and Mn. A preferred example of the lithium composite oxide is a composite oxide represented by a general formula: LiMO₂ (where M is Ni and X, X is a metal element other than Ni, and the ratio of Ni is greater than or equal to 50 mol % and less than or equal to 95 mol % based on the total number of moles of the metal element except Li). Examples of X in the above formula include Co, Mn, Al, B, Mg, Ti, V, Cr, Fe, Cu, Zn, Ga, Sr, Zr, Nb, In, Sn, Ta, and W.

Examples of the conductive agent contained in the positive electrode mixture layer include carbon materials such as carbon black, acetylene black, Ketjenblack, and graphite. These conductive agents may be used alone or in combination of two or more thereof. A content of the conductive agent in the positive electrode mixture layer is, for example, preferably greater than or equal to 0.5 mass % and less than or equal to 4 mass %, and more preferably greater than or equal to 0.5 mass % and less than or equal to 1.5 mass %.

Examples of the binder contained in the positive electrode mixture layer include a fluororesin such as polytetrafluoroethylene (PTFE) or polyvinylidene fluoride (PVdF), polyacrylonitrile (PAN), a polyimide-based resin, an acrylic resin, a polyolefin-based resin, styrene-butadiene rubber (SBR), carboxymethyl cellulose (CMC) or a salt thereof, polyacrylic acid (PAA) or a salt thereof (PAA-Na, PAA-K, and the like, or a partially neutralized salt may be used), polyethylene oxide (PEG), and polyvinyl alcohol (PVA). These conductive agents may be used alone or in combination of two or more thereof. A content of the binder in the positive electrode mixture layer is, for example, preferably greater than or equal to 0.5 mass % and less than or equal to 4 mass %, and more preferably greater than or equal to 0.5 mass % and less than or equal to 1.5 mass %.

### [Negative Electrode]

The negative electrode 12 includes, for example, a negative electrode current collector and a negative electrode mixture layer formed on the current collector. As the negative electrode current collector, a foil of a metal stable in a potential range of the negative electrode, such as copper, a film in which the metal is disposed on a surface layer, or the like can be used. The negative electrode mixture layer contains, for example, a negative electrode active material, a binder, and the like. The negative electrode 12 can be manufactured, for example, as follows. First, a negative electrode active material, a binder, and the like are mixed, and the mixture is dispersed in a solvent to prepare a negative electrode mixture slurry. The negative electrode mixture slurry is applied onto the negative electrode current collector, a coating film is dried, and then the coating film is rolled, such that the negative electrode 12 can be manufactured.

The negative electrode active material is, for example, a material capable of occluding and releasing lithium ions. Specific examples of the negative electrode active material include metal lithium, lithium alloys such as a lithium-aluminum alloy, a lithium-lead alloy, a lithium-silicon alloy, and a lithium-tin alloy, carbon materials such as graphite, coke, and organic substance baked bodies, and metal oxides such as SnO₂, SnO, and TiO₂. These negative electrode active materials may be used alone or in combination of two or more thereof.

Examples of the binder contained in the negative electrode mixture layer include a fluorine-based resin, PAN, a polyimide-based resin, an acrylic resin, a polyolefin-based resin, SBR, CMC or a salt thereof, PAA or a salt thereof, PEO, and PVA as in the case of the positive electrode. Note that the negative electrode mixture layer may contain a conductive agent as in the case of the positive electrode.

### [Separator]

As the separator 13, for example, a porous sheet having an ion permeation property and an insulation property is used. Specific examples of the porous sheet include a fine porous thin film, a woven fabric, and a non-woven fabric. The separator 13 is formed of for example, a polyolefin such as polyethylene or polypropylene, or cellulose. The separator 13 may be a laminate including a cellulose fiber layer and a thermoplastic resin fiber layer formed of a polyolefin or the like. In addition, the separator 13 may be a multi-layer separator including a polyethylene layer and a polypropylene layer, and may have a surface layer formed of an aramid resin or a surface layer including an inorganic filler.

### [Non-Aqueous Electrolyte]

The non-aqueous electrolyte contains 1,2-dimethoxyethane. A content of 1,2 dimethoxyethane is less than or equal to 700 ppm with respect to the total mass of the non-aqueous electrolyte. As described above, it is presumed that the SEI film formed on the surface of the negative electrode active material is stabilized by 1,2-dimethoxyethane in the non-aqueous electrolyte, and thus, the high-temperature storage characteristics of the battery are improved. However, when the content of 1,2-dimethoxyethane increases, the high-temperature storage characteristics are deteriorated as the amount of 1,2-dimethoxyethane that decomposes during high-temperature storage of the battery is increased. Therefore, an upper limit of the content of 1,2-dimethoxyethane needs to be set to 700 ppm with respect to the total mass of the non-aqueous electrolyte. A lower limit of the content of 1,2-dimethoxyethane is preferably greater than or equal to 10 ppm, and more preferably greater than or equal to 200 ppm, with respect to the total mass of the non-aqueous electrolyte, from the viewpoint of further improving the high-temperature storage characteristics of the battery.

In addition, the non-aqueous electrolyte preferably contains lithium difluorophosphate. A combination of lithium difluorophosphate and 1,2-dimethoxyethane may further improve the high-temperature storage characteristics of the battery, A content of lithium difluorophosphate is, for example, preferably greater than or equal to 0.1 mass % and less than or equal to 1 mass % with respect to the total mass of the non-aqueous electrolyte from the viewpoint of further improving the high-temperature storage characteristics of the battery.

In addition, the non-aqueous electrolyte contains a non-aqueous solvent in addition to 1,2-dimethoxyethane. Examples of the non-aqueous solvent include esters, ethers, nitriles such as acetonitrile, amides such as dimethylformamide, and a mixed solvent of two or more thereof. The non-aqueous solvent may contain a halogen-substituted product in which at least some of hydrogen in any of the solvents described above is substituted with a halogen atom such as fluorine.

Examples of the esters include cyclic carbonates such as ethylene carbonate (EC), propylene carbonate (PC), and butylene carbonate, chain carbonates such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylic acid esters such as γ-butyrolactone and γ-valerolactone, and chain carboxylic acid esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, propionitrile, butyronitrile, valeronitrile, n-heptanonitrile, succinonitrile, glutaronitrile, adiponitrile, pimelonitrile, 1,2,3-propane tricarbonitrile, and 1,3,5-pentane tricarbonitrile.

Examples of the halogen-substituted product include fluorinated cyclic carbonic acid ester such as fluoroethylene carbonate (FEC), fluorinated chain carbonic acid ester, and fluorinated chain carboxylic acid ester such as methyl fluoropropionate (FMP).

In addition, the non-aqueous electrolyte contains an electrolyte salt. Examples of the electrolyte salt include borates such as LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n is 1 or 2), LiB₁₀Cl₁₀, LiCl, LiBr, LiI, lithium chloroborane, lithium lower aliphatic carboxylate, Li₂B₄O₇, and Li(B(C₂O₄F₂), and imide salts such as LiN(SO₂CF₃)₂ and LiN(C₁F₂ₗ₊₁SO₂)(CₘF₂ₘ₊₁SO₂) {l and m are integers greater than or equal to 1}. These electrolyte salts may be used alone or in combination of a plurality of kinds thereof. A concentration of the electrolyte salt is, for example, greater than or equal to 0.8 mol and less than or equal to 1.8 mol per 1 L of the non-aqueous solvent.

### EXAMPLES

Hereinafter, the present disclosure will be further described with reference to Examples, but the present disclosure is not limited to these Examples.

### Example 1

### [Manufacture of Positive Electrode]

As a positive electrode active material, a lithium composite oxide represented by LiNi_{0.88}Co_{0.09}Al_{0.03}O₂ was used. 100 parts by mass of the positive electrode active material, 1 part by mass of acetylene black, and 0.9 parts by mass of polyvinylidene fluoride were mixed in a solvent of N-methyl-2-pyrrolidone (NMP) to prepare a positive electrode mixture slurry. The slurry was applied onto both surfaces of a positive electrode current collector formed of an aluminum foil, a coating film was dried, and then the coating film was rolled by a rolling roller, thereby manufacturing a positive electrode in which a positive electrode mixture layer was formed on both surfaces of a positive electrode current collector.

### [Manufacture of Negative Electrode]

95 parts by mass of graphite powder and 5 parts by mass of silicon oxide were mixed. The mixture was used as a negative electrode active material. Then, 100 parts by mass of the negative electrode active material, 1 part by mass of carboxymethyl cellulose (CMC), and 1 part by mass of a dispersion of styrene butadiene rubber (SBR) were dispersed in water to prepare a negative electrode composite slurry. The slurry was applied onto both surfaces of a negative electrode current collector formed of a copper foil, a coating film was dried, and then the coating film was rolled by a rolling roller, thereby manufacturing a negative electrode in which a negative electrode mixture layer was formed on both surfaces of a negative electrode current collector.

### [Preparation of Non-Aqueous Electrolyte]

LiPF₆ was dissolved, at a concentration of 1.4 mol/L, in a mixed solvent obtained by mixing ethylene carbonate (EC), methyl ethyl carbonate (MEC), and dimethyl carbonate (DMC) at a volume ratio of 20:5:75, 3 mass % of vinylene carbonate (VC) was further added, and 1,2-dimethoxyethane was added in the following amount, thereby obtaining a non-aqueous electrolyte. The content of 1,2-dimethoxyethane was set to 200 ppm with respect to the total mass of the non-aqueous electrolyte.

### [Manufacture of Non-Aqueous Electrolyte Secondary Battery]

A positive electrode lead was attached to the manufactured positive electrode, and a negative electrode lead was attached to the manufactured negative electrode. A polyethylene separator as a separator was disposed between both electrodes and wound to produce a wound electrode assembly. Insulating plates were disposed above and below the produced electrode assembly, respectively, the negative electrode lead was welded to a case body, the positive electrode lead was welded to a sealing assembly, and the electrode assembly was housed in the case body. The non-aqueous electrolyte was injected into the case body, and then, an end part of an opening of the case body was sealed with the sealing assembly via a gasket. This was used as a non-aqueous electrolyte secondary battery.

### Example 2

A non-aqueous electrolyte secondary battery was manufactured in the same manner as in Example 1, except that in the preparation of the non-aqueous electrolyte, the content of 1,2-dimethoxyethane was 700 ppm with respect to the total mass of the non-aqueous electrolyte.

### Comparative Example 1

A non-aqueous electrolyte secondary battery was manufactured in the same manner as in Example 1, except that in the preparation of the non-aqueous electrolyte, 1,2-dimethoxyethane was not added.

### Comparative Example 2

A non-aqueous electrolyte secondary battery was manufactured in the same manner as in Example 1, except that in the preparation of the non-aqueous electrolyte, the content of 1,2-dimethoxyethane was 1,000 ppm with respect to the total mass of the non-aqueous electrolyte.

The following measurement was performed for each of Examples and each of Comparative Examples to evaluate the high-temperature storage characteristics.

### [Measurement of Capacity Retention Rate After High-Temperature Storage]

The non-aqueous electrolyte secondary battery of each of Examples and each of Comparative Examples was subjected to constant current charge at a constant current of 990 mA (0.3 C) until a battery voltage reached 4.2 V, and then subjected to constant voltage charge at a constant voltage of 1.2 V until a final current reached 66 mA under a temperature environment of 25° C. Then, constant current discharge was performed at a constant current of 990 mA (0.3 C) until a battery voltage reached 3 V. The discharge capacity at this time was defined as an initial discharge capacity. Thereafter, the non-aqueous electrolyte secondary battery was subjected to constant current charge at a constant current of 990 mA (0.3 C) until a battery voltage reached 4.2 V, and then subjected to constant voltage charge at a constant voltage of 4.2 V until a final current reached 66 mA so that the battery was in a state of SOC 100%. Then, the non-aqueous electrolyte secondary battery of each of Examples and each of Comparative Examples was put in a thermostatic bath and stored under an environment of 80° C. for 72 hours. Then, the non-aqueous electrolyte secondary battery of each of Examples and each of Comparative Examples was taken out from the thermostatic bath, naturally cooled to around room temperature, and then subjected to constant current discharge at a constant current of 990 mA (0.3 C) until the battery voltage reached 3 V The discharge capacity at this time was defined as a discharge capacity after storage. Then, the capacity retention rate after high-temperature storage was calculated by the following equation.

Capacity retention rate after high-temperature storage:=(Discharge capacity after storage/Initial discharge capacity)×100

### [Measurement of Amount of Gas Generated During High-Temperature Storage]

The non-aqueous electrolyte secondary battery of each of Examples and each of Comparative Examples was subjected to constant current charge at a constant current of 990 mA (0.3 C) until a battery voltage reached 4.2 V, and then subjected to constant voltage charge at a constant voltage of 4.2 V until a final current reached 66 mA under a temperature environment of 25° C. so that the battery was in a state of SOC 100%. Then, the non-aqueous electrolyte secondary battery of each of Examples and each of Comparative Examples was put in a thermostatic bath and stored under an environment of 80° C. for 72 hours. Then, the non-aqueous electrolyte secondary battery of each of Examples and each of Comparative Examples was taken out from the thermostatic bath, naturally cooled to around room temperature, and then subjected to constant current discharge at a constant current of 990 mA (0.3 C) until the battery voltage reached 3 V A hole was formed in the case body of the battery after the discharge, the gas inside the battery was collected, and the gas amount was measured.

Table 1 summarizes the results of the capacity retention rate after high-temperature storage and the amount of gas generated during high-temperature storage. Note that, as for the amount of gas generated during high-temperature storage, other Examples and Comparative Examples are shown relatively with Comparative Example 1 as a reference (100).

TABLE 1

| | | | Capacity retention rate | Amount of gas |
|---|---|---|---|---|
| | Content of 1,2- | | after high-temperature | generated during high- |
| | dimethoxyethane | | storage | temperature storage |
| Example 1 | 200 | ppm | 95.0% | 92.5 |
| Example 2 | 700 | ppm | 94.8% | 98.5 |
| Comparative | — | | 93.5% | 100 |
| Example 1 | | | | |
| Comparative | 1000 | ppm | 94.1% | 107.5 |

Example 2

The non-aqueous electrolyte secondary batteries of Examples 1 and 2 had a higher capacity retention rate after high-temperature storage and a lower amount of gas generated during high-temperature storage than the non-aqueous electrolyte secondary batteries of Comparative Examples 1 and 2. Therefore, it can be said that a non-aqueous electrolyte secondary battery containing 1,2-dimethoxyethane, in which a content of the 1,2-dimethoxyethane is less than or equal to 700 ppm with respect to the total mass of the non-aqueous electrolyte, has excellent high-temperature storage characteristics.

### REFERENCE SIGNS LIST

10 Secondary battery
11 Positive electrode
12 Negative electrode
13 Separator
14 Electrode assembly
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket

1. A non-aqueous electrolyte secondary battery comprising: a positive electrode, a negative electrode, and a non-aqueous electrolyte,
wherein the non-aqueous electrolyte contains 1,2-dimethoxyethane, and
a content of the 1,2-dimethoxyethane is less than or equal to 700 ppm with respect to the total mass of the non-aqueous electrolyte.

2. The non-aqueous electrolyte secondary battery according to claim 1, wherein the content of the 1,2-dimethoxyethane is greater than or equal to 200 ppm with respect to the total mass of the non-aqueous electrolyte.

3. The non-aqueous electrolyte secondary battery according to claim 1, wherein the non-aqueous electrolyte contains lithium difluorophosphate.

4. The non-aqueous electrolyte secondary battery according to claim 3, wherein a content of the lithium difluorophosphate is greater than or equal to 0.1 mass % and less than or equal to 1 mass % with respect to the total mass of the non-aqueous electrolyte.
